(19) United States
(12) Patent Application Publication
(10) Pub. No.: US 2006/0127726 A1
(43) Pub. Date: Jun. 15, 2006

(54) SOLID ELECTROLYTE BASED ON MAGNESIA-DOPED CERIA

(76) Inventors: Feng-Yun Wang, Taipei (TW); Soofin Cheng, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/905,084

(22) Filed: Dec. 14, 2004

(51) Int. Cl. H01M 8/12; C01F 11/02; C01F 5/00

(52) U.S. Cl. 429/33; 423/594.16

(57) ABSTRACT

A solid electrolyte based on magnesia-doped ceria is described, having a composition represented by general formula Ce_{1-x-y}MₓMg_{y}O_{2-d}, wherein M stands for Y, Ca or Sr, and the ranges of x and y are defined by the inequalities of 0.01≦x<0.3, 0.01≦y≦0.6 and 0.02≦x+y≦0.7. The composition can be formed into a sintered body suitably used as an oxygen-ion conducting solid electrolyte of an intermediate-temperature solid oxide fuel cell or other electrochemical devices. The solid electrolyte with suitable values of x and y have low cost, high stability and acceptable ionic conductivity as compared with similarly prepared Gd-doped ceria electrolyte.

### BACKGROUND OF THE INVENTION

1. Field of the Invention

The present invention relates to a solid electrolyte and more particularly to an oxygen-ion conducting solid electrolyte suitably used in intermediate-temperature solid oxide fuel cells and other electrochemical devices, such as, oxygen concentrators, oxygen sensors, and so on.

2. Description of the Related Art

Oxygen-ion conducting solid electrolytes are the most important materials of many electrochemical devices, such as, solid oxide fuel cells (SOFCs) that generate electricity efficiently and environmental-friendly directly through electrochemical reactions of fuels and oxygen, oxygen concentrators that separate oxygen from oxygen-containing gases to produce pure oxygen, and oxygen sensors that measure oxygen concentration in gaseous mixtures, and so on.

Desirable properties for oxygen-ion conducting solid electrolytes include high oxygen-ionic conductivity, high stability and relatively low cost. Yttrium-stabilized zirconia (YSZ) has been widely used as an oxygen-ion conducting solid electrolyte, but its conductivity in the intermediate temperature (IT) range of 500-700° C. is too low to meet the commercial requirement. As a result, SOFCs with YSZ as the electrolyte usually needs to be operated at 900-1000° C. so as to have an acceptable power output. Such a high operating temperature places considerable constraints on the materials that can be used for interconnects and balance of plant.

To solve this problem, many researches have been carried out to develop new solid electrolytes of higher ionic conductivity than YSZ in IT range, and doped ceria materials have been found promising. While a wide variety of dopants have been shown to be effective in increasing oxygen ionic conductivity of doped ceria, alkaline earth and rare earth metal cations, especially Gd³⁺ and Sm³⁺, are considered to be preferable.

Inaba and Tagawa [Solid State Ionics, 83 (1996) 1] have reviewed the effects of various dopants on the ionic conductivity of doped ceria, and found that rare earth metal ions, except La³⁺, were all better than alkaline earth metal ions, while Sm³⁺ was the best among the rare earth metal ions. However, Steele [Solid State Ionics, 129 (2000) 95] and Herle et al. [Solid State Ionics, 86-88 (1996) 1255-1258] reported that Gd³⁺ was better than Sm³⁺. No matter which one of the two dopants is the best, the doped ceria with either Gd³⁺ or Sm³⁺ has ionic conductivity much higher than YSZ in IT range. However, they still suffer from partial reduction in reducing environment, which leads to lower stability and lower power output of the fuel cells.

In order to overcome the problem and/or further improve the ionic conductivity, many studies have turned to co-doped ceria. For example, in U.S. Pat. No. 5,001,021, Ce_{0.8}Gd_{0.19}Pr_{0.01}O_{2-d} was found better than Ce_{0.8}Gd_{0.2}O_{2-d} in both anti-reduction and ionic conductivity at 700° C. In U.S. Pat. No. 3,607,424, Ce_{0.685}Gd_{0.274}Mg_{0.041}O_{2-d} was found better than Ce_{0.685}Gd_{0.315}O_{2-d} in ionic conductivity at 723° C.

In US 2003/0027027, Ce_{0.895}Sm_{0.10}Mg_{0.005}O_{2-d} and Ce_{0.845}Sm_{0.15}Ti_{0.0025}Mg_{0.0025}O_{2-d} were studied, where the small amount of MgO was considered a sintering aid and performed better than CaO and SrO. In U.S. Pat. No. 5,378,345, Ce_{0.88}Y_{0.02}Ca_{0.01}O_{2-d} was made and used as the electrolyte material of an electrochemical oxygen concentrator cell.

In addition to the instability due to partial reduction, doped ceria electrolytes reported so far are considered very expensive. Literature search has revealed that no matter ceria is singly or multiply doped, the dopants were usually selected from either rare earth metal ions or alkaline earth metal ions, or both of them, and the total content of the rare earth metal ions (including Ce⁴⁺) in the electrolytes is usually more than 90 mol % of all the metal ions. Since rare earth metal materials are relatively expensive, the costs of the doped ceria electrolytes being reported so far in the literatures are still very high.

### SUMMARY OF THE INVENTION

It is, therefore, one object of this invention to provide a solid electrolyte which has low cost, high stability, and acceptable ionic conductivity as compared with the similarly prepared Ce_{0.9}Gd_{0.1}O_{1.95} electrolyte (termed as CGO, hereinafter).

The object can be achieved by co-doping ceria with large quantity of some relatively cheap dopants. The composition of the solid electrolyte provided in the present invention can be represented by general formula Ce_{1-x-y}MₓMg_{y}O_{2-d}, wherein M stands for Y, Ca or Sr, and the values of x and y are defined by the inequalities of 0.01≦x<0.3, 0.01≦y≦0.6 and 0.02≦x+y≦0.7. The meaning of the nomination (2-d) of the oxygen number is well known, and is described in the reference documents.

In the cases of y≦0.05, the electrolytes of this invention consist of a single phase of ceria-based solid solution. However, in the cases of y>05, the electrolytes of this invention consist of two phases, i.e., ceria-based solid solution and free MgO.

In addition, the electrolytes of this invention with suitable values of x and y have higher stability and lower cost than CGO and acceptable ionic conductivity close to that of CGO. The suitable values of x and y can be realized from the descriptions of the preferred embodiments of this invention.

It is to be understood that both the foregoing general description and the following detailed description are exemplary, and are intended to provide further explanation of the invention as claimed.

### BRIEF DESCRIPTION OF THE DRAWINGS

FIG. 1 shows the XRD patterns (Cu target) of pure CeO₂ and the electrolytes with the composition of Ce_{1-x-y}YₓMg_{y}O_{1.618}, wherein y=0.382−0.5x and 0≦x≦0.765.

FIG. 2 shows the XRD patterns of pure CeO₂ and the electrolytes with the composition of Ce_{0.935-y}Y_{0.065}Mg_{y}O_{1.9675-y}, wherein 0≦y≦0.35.

FIG. 3 shows the XRD patterns of (a) pure MgO; (b) pure CeO₂; (c) Ce_{0.450}Y_{0.050}Mg_{0.500}O_{1.475}, calcined at 700° C. for 4 h; and (d) Ce_{0.450}Y_{0.050}Mg_{0.500}O_{1.475}, sintered at 1500° C. for 14 h.

FIG. 4 shows the effect of temperature on the conductivities in air of CGO and the electrolytes with the composition of Ce_{1-x-y}YₓMg_{y}O_{1.618}, wherein y=0.382−0.5x and 0≦x≦0.765.

FIG. 5 shows the effect of Y content on the conductivity of Ce_{1-x-y}YₓMg_{y}O_{1.618} in air at 600° C., wherein y=0.382−0.5x and 0≦x≦0.765.

FIG. 6 shows the effect of temperature on the conductivities in air of CGO and the electrolytes with the composition of Ce_{0.935-y}Y_{0.065}Mg_{y}O_{1.9675-y}, wherein 0≦y≦0.35.

FIG. 7 shows the effect of temperature on the conductivities in air of different electrolytes. (□) CGO, (●) Ce_{0.65}Mg_{0.35}O_{1.65}, (▴) Ce_{0.585}Y_{0.065}Mg_{0.35}O_{1.618}, (◯) (78% mol Ce_{0.585}Y_{0.065}Mg_{0.35}O_{1.618} +22 mol % MgO).

FIG. 8 shows the variation of the conductivity of Ce_{0.935}Y_{0.065}O_{1.9675} with time at 700° C. sequentially in different gases.

FIG. 9 shows the variation of the conductivity of Ce_{0.585}Y_{0.065}Mg_{0.350}O_{1.618} with time at 700° C. sequentially in different gases.

FIG. 10 shows the variation of the conductivity of Ce_{0.585}Y_{0.065}Mg_{0.350}O_{1.618} with time at 700° C. sequentially in different gases. The process in 10% H₂/N₂ took a longer time than the corresponding process shown in FIG. 9.

FIG. 11 shows the variation of the conductivity of the electrolyte with the composition of (78% Ce_{0.585}Y_{0.065}Mg_{0.35}O_{1.65}+22% MgO). Treatment A is conducted in air from 200° C. to 700° C. for 5 h, in 10% H₂/N₂ at 700° C. for 3 h, and then in air again at 700° C. for 4 h. Treatment B is conducted in pure H₂ at 700° C. for 3.5 h.

FIG. 12 shows the variation of the conductivity of CGO with time at 700° C. sequentially in different gases.

FIG. 13 shows the effect of dopant type on the conductivity of the samples with a nominal composition of Ce_{0.45}M_{0.05}Mg_{0.5}O_{2-d} (M=Y, Ca or Sr) in air at different temperatures.

### DESCRIPTION OF THE PREFERRED EMBODIMENTS

As mentioned above, the electrolyte composition of the present invention can be represented by the following general formula: Ce_{1-x-y}MₓMg_{y}O_{2-d}, wherein M stands for Y, Ca or Sr, and x and y are the atomic fractions of M and Mg, respectively.

The atomic fraction “x” of M and that (y) of Mg are chosen to maximize the ionic conductivity and the stability of the electrolyte as well as to minimize the cost of the electrolyte. In the present composition, the value of “x” is selected within the range from 0.01 to about 0.3, preferably within the range from about 0.04 to about 0.2, and more preferably within the range from about 0.05 to about 0.1. The value of “y” is selected within the range from 0.01 to about of 0.6, preferably with in the range from about 0.05 to about 0.55, and more preferably within the range from about 0.3 to about 0.5. The sum of x and y (x+y) is within the range from about 0.02 to about 0.7, preferably within the range from about 0.09 to about 0.6, and more preferably within the range from about 0.3 to about 0.55.

The electrolyte may be made with a conventional solid-state reaction method using respective oxide raw materials or inorganic precursor materials which decompose under suitable conditions to yield oxide products.

Preferably, the electrolyte is prepared using a citrate method that includes the following steps. Nitrate solutions of the required metal ions are prepared respectively, and are then mixed to formulate a desired composition. Some solution of citric acid (CA) and polyethylene glycol (PEG) is added until the molar number of CA is equal to or more than the total molar number of the metal ions, while the weight ratio of CA to PEG is 9-60. The mixed solution is stirred and evaporated at 60-80° C. until it is gelled, and the gel is calcined at 700° C. for 4 hours and then grounded into fine powder. The powder is pressed into a raw pellet, and the raw pellet is sintered at 1500° C. for 14 hours and then cooed to room temperature.

Upon examining the crystal structures through X-ray diffraction, it was revealed that for the compositions of the present invention, a calcined product had the same XRD patterns as that of the subsequently sintered product except that the peaks in the latter were sharper. This indicates that the calcined product already has the final crystal structure of the electrolyte, while the sintering process merely increases the compaction and the crystal size of the shaped product.

For the composition (Ce_{1-x-y}MₓMg_{y}O_{2-d}) of the present invention, it was found that when y is less than about 0.05 and the sum of x and y is less than about 0.2, the electrolyte is constituted of a single phase of ceria-based solid solution. However, when y is larger than about 0.05, the electrolyte is constituted of two phases, i.e., ceria-based solid solution and free MgO.

FIG. 1 shows the XRD patterns of the electrolytes with the composition of general formula Ce_{1-x-y}YₓMg_{y}O_{1.618}, wherein y=0.382−0.5x and 0≦x≦0.765. It seems that the electrolytes had the XRD patterns similar to that of pure ceria. However, when the XRD patterns were amplified to a sufficient extent, the peak of free MgO was observed at about 430. This suggests that the samples were all two-phase materials, wherein the major phase was co-doped ceria solid solution, and the minor phase was free MgO.

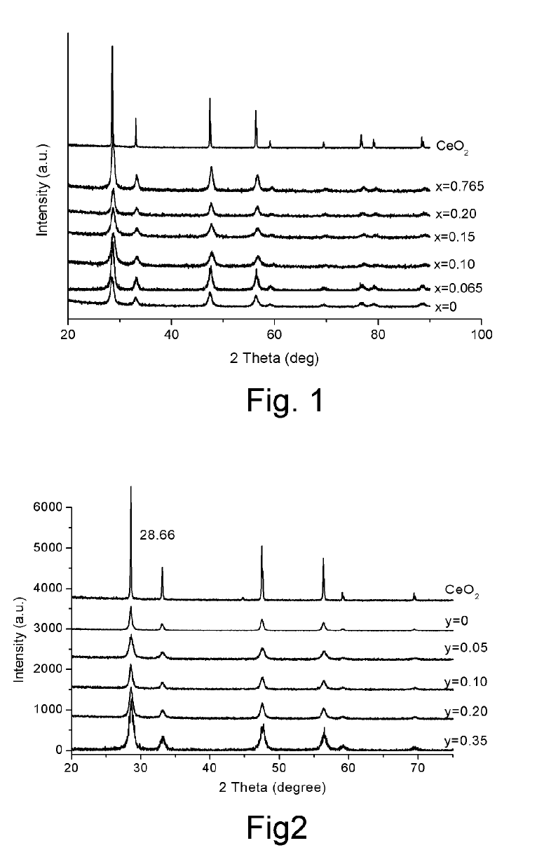

FIG. 2 shows the XRD patterns of the electrolytes with the composition of general formula Ce_{0.935-y}Y_{0.065}Mg_{y}O_{1.9675-y}, wherein 0≦y≦0.35. All the electrolytes seem to have the same XRD patterns as that of pure ceria. However, when the patterns was amplified to a sufficient extent, the peak of free MgO was observed at about 430 for the samples with y>0.05. This suggests that the electrolytes with y≦0.05 have a single phase of ceria-based solid solutions, whereas the electrolytes with y>0.05 are two-phase materials including free MgO and ceria-based solid solution.

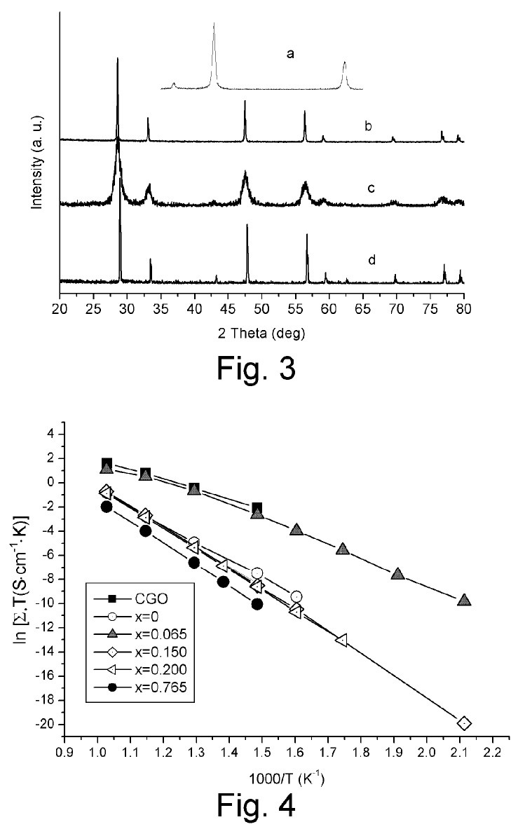

FIG. 3 shows the XRD patterns of the electrolyte with the nominal composition of Ce_{0.450}Y_{0.050}Mg_{0.500}O_{1.475}. Clearly, the electrolyte, no matter calcined or sintered, has the same XRD patterns as pure ceria except an extra small peak of MgO emerging at about 43°. Therefore, it can be concluded that the electrolyte is composed of two phases. One is Y/Mg co-doped ceria solid solution, and the other is free MgO.

FIG. 4 shows the conductivity of the electrolytes with the composition of general formula Ce_{1-x-y}YₓMg_{y}O_{1.618} in air at different temperatures, wherein y=0.382−0.5x and 0≦x≦0.765. Obviously, the electrolyte of x=0.065 has the lowest activation energy in conduction and the highest conductivity which is close to that of CGO.

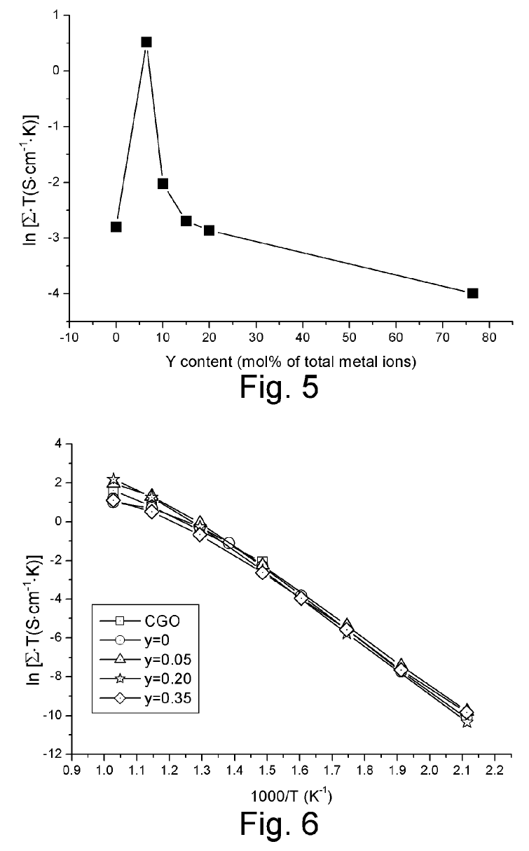

FIG. 5 shows the effect of Y content on the conductivity of the same electrolytes as in FIG. 4 in air at 600° C. The maximal conductivity emerges at the point of x=0.065. This is similar to the result of Y-doped ceria as reported in the literature [Hideaki Inaba and Hiroaki Tagawa, “Ceria-based Solid Electrolyte”, Solid State Ionics, 83 (1996) 1], wherein the maximal conductivity emerges at the composition of Ce_{0.923}Y_{0.076}O_{1.96}.

FIG. 6 shows the conductivity of the electrolytes with the composition of general formula Ce_{0.935-y}Y_{0.065}Mg_{y}O_{1.9675-y} in air at different temperatures, wherein 0≦y≦0.35. The effect of Mg content on both the conductivity and the activation energy in conduction of the electrolytes is negligible below 500° C., but detectable above 500° C. The conductivities of all the electrolytes are close to that of CGO.

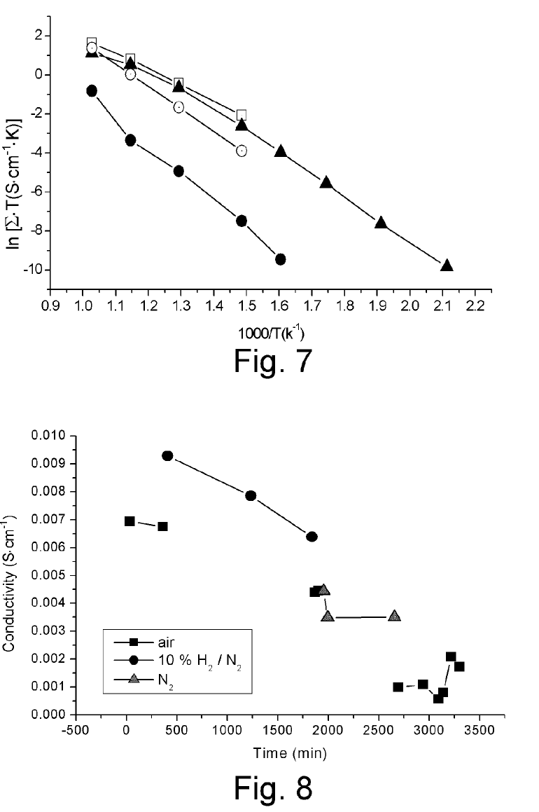

FIG. 7 shows the effect of Y dopant and Mg content on the conductivities of the ceria-based electrolytes. It can be seen that the Y dopant was vital for the electrolytes to have high ionic conductivity. The Mg content has some negative effect on conductivity, since the higher the Mg content, the higher the activation energy of ion conduction. However, at 700° C., the conductivities of the two Y-containing electrolytes were very close to that of CGO.

The stability of the electrolytes of the present invention has been tested by monitoring the conductivity of the electrolytes at 700° C. in different gases for a sufficient time, and has been compared with that of CGO.

FIG. 8 shows the variations of conductivity of Ce_{0.935}Y_{0.065}O_{1.9675} with time at 700° C. sequentially in different gases. Generally, the conductivity in any gas apparently decreases with time, indicating that this material is not stable at 700° C.

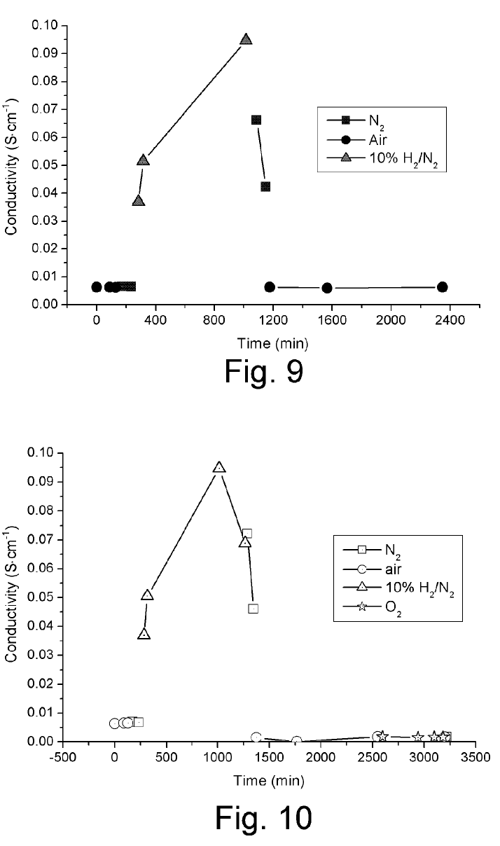

FIG. 9 shows the variations of conductivity of Ce_{0.585}Y_{0.065}Mg_{0.350}O_{1.618} with time at 700° C. sequentially in different gases. The conductivities of the sample in air and N₂ were very close, indicating that the conduction types of the sample under these conditions are ionic conduction. However, when the gas was switched to 10% H₂/N₂, the conductivity of the sample increased rapidly with time. This is because the sample is partially reduced under the reducing environment, which causes electronic conduction and increases the ionic conduction. When the gas was switched back to N₂ for a while, due to the partial oxidation of the reduced sample by the minor oxygen in the N₂ flow, the conductivity of the sample decreases steeply but not down to the level before the reduction reaction. However, when the gas was switched back to air, due to the complete oxidation of the reduced sample by the O₂ in air, the conductivity of the sample returned to its starting level and did not vary with time any more.

However, as shown in FIG. 10, if the reduction process goes more than 13 h, the sample might be over-reduced, and its structure might be partially changed and could not be re-oxidized back to its original. Therefore, the conductivity in air after the reduction reaction was lower than that before the reduction reaction, even if the exposure time in air is more than 20 h.

The results in FIG. 9 and FIG. 10 indicate that Ce_{0.585}Y_{0.065}Mg_{0.350}O_{1.618} at 700° C. is stable in air and N₂ but not stable enough in 10% H₂/N₂. Comparing FIG. 9 and FIG. 10 with FIG. 8, it can be concluded that the addition of Mg dopant to the Y-doped ceria benefits the stability of the electrolyte.

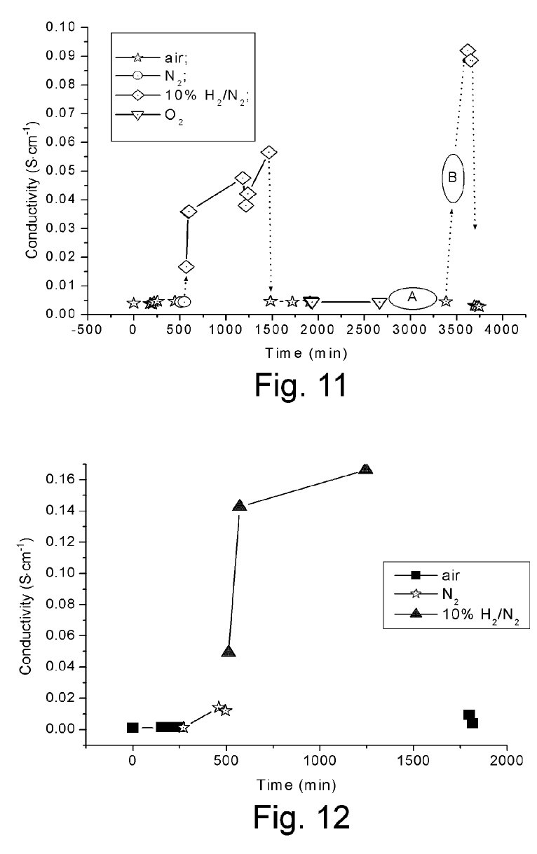

FIG. 11 shows the variation of the conductivity of Ce_{0.450}Y_{0.050}Mg_{0.500}O_{1.475} with time at 700° C. sequentially in different gases. Similar to FIG. 9, the conductivities of the sample in air and N₂ were very close, indicating that the conduction types of the sample under these conditions are ionic conduction. However, when the gas was switched to 10% H₂/N₂, the conductivity of the sample increased rapidly with time. This is because the sample is partially reduced under the reducing environment. When the gas was switched back to air, due to the complete oxidation of the reduced sample by O₂ in air, the conductivity of the sample returns to its starting level and did not change with time. When the gas was switched to pure O₂, the conductivity was close to that in air and did not vary with time, further indicating that the conduction type of the sample is ionic conduction. After being switched to air for a while, the gas is switched to pure hydrogen, and the conductivity increased rapidly with time. After 3.5 h in hydrogen, the gas is switched back to air again, and the conductivity in air is found still close to the original value. Comparing FIG. 11 with FIGS. 8 and 9, it can be concluded that the presence of free MgO benefits the stability of the electrolyte.

For comparison, the stability of CGO was also tested by monitoring its conductivity change with time at 700° C. in different gases. As shown in FIG. 12, the conductivity in air did not vary apparently with time. However, when the gas was switched to N₂, the conductivity increased with time up to a level of 10 times as high as that in air. This indicates that, in N₂ and at 700° C., CGO may lose crystal oxygen, which causes electronic conduction and increases the ionic conduction, and consequently causes considerable increase in total conductivity. When the gas was switched to 10% H₂/N₂, owing to partial reduction, the conductivity of the electrolyte increased rapidly with time. When the gas was switched back to air, the conductivity decreased rapidly with time down to the level slightly higher than the value before the process in N₂ and H₂. In general, the result in FIG. 12 indicates that CGO is stable in air, but is prone to be reduced in reducing gases, even in N₂.

Comparing FIG. 12 with FIG. 8, 9, and 11, it can be concluded that the stability of the electrolytes increases in the following order: Ce_{0.935}Y_{0.065}O_{1.9675}<CGO<Ce_{0.585}Y_{0.065}Mg_{0.350}O_{1.618}<Ce_{0.450}Y_{0.050}Mg_{0.500}O_{1.475}. MgO is much more stable than rare earth oxides even in reducing environment. When free MgO is present in the electrolyte, it is most probably distributed on the crystal surface of the ceria-based solid solution, which prevents the reduction of lattice Ce⁴⁺ and consequently improves the stability of the electrolytes.

In addition to the stability, because MgO is much cheaper than rare earth oxides, the costs of the electrolytes of the present invention are reduced greatly by raising the content of MgO in the electrolytes to a high level.

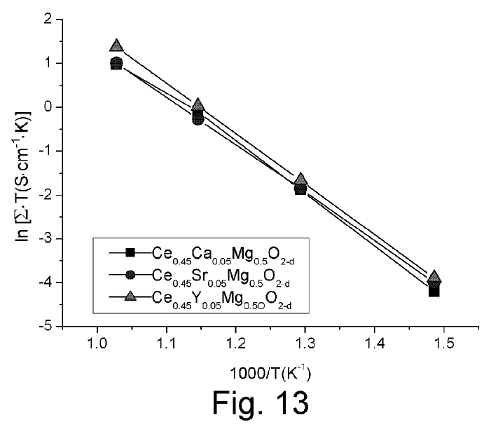

When Y³⁺ in the samples with nominal composition of Ce_{1-x-y}MₓMg_{y}O_{2-d}, wherein 0.01<x<0.3, 0.01<y<0.6, was replaced by Ca²⁺ or Sr²⁺, the replaced samples were still single-phase materials of ceria-based solid solution as y<0.05, or two-phase materials consisting of free MgO and ceria-based solid solution as y≧0.05. However, as shown in FIG. 13, the conductivities of the replaced samples in air were a little lower than that with Y³⁺ as dopant, but the costs of the same were much lower.

Several examples are provided below to further explain this invention. I is noted that the examples are not intended to restrict the scope of this invention.

### EXAMPLE 1

Ce(NO₃)₃.6H₂O, Y(NO₃) ₃.6H₂O, Mg(NO₃)₂.6H₂O and Gd(NO₃) ₃.5H₂O were used as starting materials to produce solid electrolytes. At first, metal ion solutions are prepared by dissolving the nitrate salts respectively into distilled water and diluting them to given concentrations. The concentrations of the Ce³⁺ solution, Y³⁺ solution, Mg²⁺ solution and Gd³⁺ solution are 1.3M, 0.5M, 1.0M and 0.5M, respectively. A solution of citric acid (CA) and polyethylene glycol (PEG) of molecular weight 600 was prepared by dissolving CA and PEG with a weight ratio of CA to PEG being 60 into distilled water, and diluting the solution to form a citric acid solution of 3.0M. This solution is simply termed as CP solution.

The above CP solution and metal ion solutions were used as basic solutions to prepare all the electrolyte samples of the present invention.

In Example 1, 20.00 ml of Ce³⁺ solution, 5.78 ml of Y³⁺ solution, 15.56 ml of Mg²⁺ solution and 14.82 ml of CP solution were mixed in a 1000 ml beaker. The mixed solution was evaporated under stirring at 80° C. until it became gelled. The gel was dried at 105° C., and ground into a powder. The powder was calcined in air at 700° C. for 4 hours, and then ground again to form a fine powder. The fine powder was uniaxially pressed under 750 MPa into raw pellets using a stainless steel die with 13 mm diameter. The raw pellets were further sintered in air at 1500° C. for 14 hours with a heating rate of 1° C./min to form dense pellets having a composition of Ce_{0.585}Y_{0.065}Mg_{0.35}O_{1.618}.

For comparison, pellets having compositions of Ce_{0.9}Gd_{0.1}O_{1.95} (CGO) were also prepared with a process analogous to that described above.

As shown in FIG. 1, the sample electrolyte of Ce_{0.585}Y_{0.065}Mg_{0.35}O_{1.618}, like the comparative electrolyte of CGO, was found to be a ceria-based solid solution of fluorite-type structure. This sample electrolyte has higher stability than CGO, as shown in FIGS. 9 and 12, and lower cost than CGO, and has ionic conductivity close to that of CGO, as shown in FIG. 4.

### EXAMPLE 2

A sample electrolyte having a composition of Ce_{0.450}Y_{0.050}Mg_{0.500}O_{1.475} was prepared with a processes analogous to that described in Example 1. As shown in FIG. 3, this electrolyte consists of two phases including ceria-based solid solution and free MgO. This electrolyte has an ionic conductivity very close to that of CGO at 700° C., as shown in FIG. 7, and has much higher stability than CGO, as shown in FIG. 11 and FIG. 12. This electrolyte is also much cheaper than CGO.

Similarly, two other samples with a nominal composition of Ce_{0.45}M_{0.05}Mg_{0.5}O_{1.45}, wherein M represent Ca or Sr, were also prepared with the same method as described in Example 1. As shown in FIG. 13, these electrolytes had conductivity in air only slightly lower than the sample with Y as dopant (Ce_{0.450}Y_{0.050}Mg_{0.500}O_{1.475}).

### EXAMPLE 3

Sample electrolytes having a nominal composition of Ce_{0.935-y}Y_{0.065}Mg_{y}O_{1.9675-y}, wherein 0≦y≦0.35, were prepared with a process analogous to that described in Example 1. As shown in FIG. 5, these sample electrolytes are all ceria-based solid solutions of fluorite-type structure. The ionic conductivities of these electrolytes are very close to that of CGO, as shown in FIG. 6.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. An electrolyte composition, represented by general formula:
Ce_{1-x-y}MₓMg_{y}O_{2-d}
wherein M represents Y, Ca or Sr, x and y are atomic fractions of M and Mg, respectively, and the ranges of x and y are defined by inequalities of 0.01≦x≦˜0.3, 0.01≦y≦˜0.6, and ˜0.02≦x+y≦˜0.7.

2. The electrolyte composition of claim 1, which exhibits an ionic conductivity close to an ionic conductivity of Ce_{0.9}Gd_{0.1}O_{1.95} electrolyte.

3. The electrolyte composition of claim 1, which exhibits higher stability and lower cost as compared with Ce_{0.9}Gd_{0.1}O_{1.95} electrolyte.

4. The electrolyte composition of claim 1, wherein x and y are further defined by inequalities of ˜0.04≦x≦˜0.2, ˜0.05≦y≦˜0.55, and ˜0.09≦x+y≦˜0.6.

5. The electrolyte composition of claim 1, wherein x and y are further defined by inequalities of ˜0.05≦x≦˜0.1, ˜0.3≦y≦˜0.5, and ˜0.3≦x+y≦˜0.55.

6. The electrolyte composition of claim 1, wherein x is larger than about 0.05 so that a phase of ceria-based solid solution and a phase of MgO are included in the electrolyte composition.
